(19) United States
(12) Patent Application Publication
(10) Pub. No.: US 2025/0347595 A1
(43) Pub. Date: Nov. 13, 2025

(54) METHOD, APPARATUS AND SYSTEM FOR THE FOR COLLECTION AND QUANTIFICATION OF MYCOTOXINS WITHIN THE BUILT ENVIRONMENT

(71) Applicant: Robert John Goldsworthy, Newcastle, New South Wales (AU)

(72) Inventor: Robert John Goldsworthy, Newcastle, New South Wales (AU)

(21) Appl. No.: 17/773,156

(22) PCT Filed: Oct. 27, 2020
(86) PCT No.: PCT/AU2020/051156

§ 371 Date: Apr. 29, 2022

(30) Foreign Application Priority Data
Oct. 30, 2019 (AU) 2019257463
Oct. 30, 2019 (AU) 2019904980
Jul. 21, 2020 (AU) 2020902519

(51) Int. Cl. G01N 1/22; B01D 39/16

(52) U.S. Cl. CPC G01N 1/2205; B01D 39/16; G01N 1/2226; B01D 2201/06; B01D 2239/1216; G01N 2001/2288

(57) ABSTRACT

A method of collection of a mycotoxin sample from an air space of an indoor environment, the method may include conditioning air, such as with an air agitator, within an air space to provide conditioned air representative of air exposed to a person within the indoor environment and sampling the air such as by filtering the conditioned air at a height within the airspace further representative of air exposed to a person within the indoor environment so as to obtain the mycotoxin sample from the conditioned air at the height. The sampling may be undertaken at a rate representative of a human respiratory rate. The mycotoxin sample may be collected by the filter and then extracted, or otherwise obtained, from the filter for identification mycotoxins that may be present in the air space. An apparatus and a system for the method are also disclosed.

### TECHNICAL FIELD

The invention relates to a method and apparatus for the collection and quantification of mycotoxins within the built environment, and, in particular, airborne mycotoxins associated fungus such mould.

### BACKGROUND

Fungus such as mould may produce chemical byproducts known as mycotoxins. Such mycotoxins may be hazardous to human health in particular when such mycotoxins are present as a result of mould within the built environment such as within a person's home.

Accordingly, methods and apparatuses have been developed to sample and test for mould within the built environment. For example, current methods may use a vacuum to collect mould spore samples from surfaces and then the samples may be tested to identify the mould type such as by crushing the spores to expose the DNA and identify the mould based on the DNA profile.

A problem with such identification of the mould species is that it does not specifically identify or allow quantification of the associated hazardous mycotoxins that may be present or to which a person may be exposed.

The invention disclosed herein seeks to overcome one or more of the above identified problems or at least provide a useful alternative.

### SUMMARY

In accordance with a first broad aspect there is provided, a method of collection of a mycotoxin sample from an air space of an indoor environment, the method including: sampling air, including filtering the air from the air space, in a condition that is representative of air exposed to a person within the indoor environment so as to collect or obtain the mycotoxin sample from air in the condition.

In accordance with a second broad aspect there is provided, a method of collection of a mycotoxin sample from an air space of an indoor environment, the method including: conditioning air within an air space to provide conditioned air representative of air exposed to a person within the indoor environment, and sampling the conditioned air by filtering the conditioned air at a height within the airspace further representative of air exposed to a person within the indoor environment so as to obtain the mycotoxin sample from the conditioned air at the height.

In accordance with a third broad aspect there is provided, a method of collection of a mycotoxin sample from an air space of an indoor environment, the method including: positioning an inlet of a sampling apparatus proximate the air space at a predetermined height; agitating air of the air space to provide conditioned air that is representative of air exposed to a person within the indoor environment; and sampling conditioned air from the air space using a filter of the sampling apparatus exposed to the conditioned air drawn through the inlet to collect the mycotoxin sample in the filter.

In accordance with a fourth broad aspect there is provided, a method of collection and identification of a mycotoxin sample from an air space of an indoor environment, the method including: locating an inlet of a sampling apparatus proximate the air space at a predetermined height; agitating air of the air space to provide conditioned air to be representative of air exposed to a person within the indoor environment; drawing air from the inlet and collecting the mycotoxin sample in a filter of the sampling apparatus; extracting from the filter the mycotoxin sample, and identification of a mycotoxin from the mycotoxin sample.

In accordance with a fifth broad aspect there is provided, an apparatus for the collection a mycotoxin sample from an air space of an indoor environment, the apparatus including: an inlet, a filter in communication with the inlet, a vacuum pump adapted to draw air from the inlet through the filter, and a stand adapted to support the inlet within an air space so as to be representative of air exposed to a person within the indoor environment.

In accordance with a sixth broad aspect there is provided, an apparatus for the collection a mycotoxin sample from an air space of an indoor environment, the apparatus including: an inlet, a filter in communication with the inlet, a vacuum pump adapted to draw air from the inlet through the filter, and a stand adapted to support the inlet within an air space at a location that is representative of air exposed to a person within the indoor environment, wherein the vacuum pump is adapted to draw air at a rate representative of a human respiratory rate and the filter is formed of a foam material adapted to scrub mycotoxins from the air at the rate.

In accordance with a seventh broad aspect there is provided, a system for the collection a mycotoxin sample from an air space of an indoor environment, the system including: an air agitator adapted to condition air of the air space to be representative of air exposed to a person within the indoor environment; a sampling apparatus including an inlet, a filter in communication with the inlet, a vacuum pump adapted to draw air from the inlet through the filter; and a stand adapted to locate the inlet within the air space at a location that is representative of air exposed to a person within the indoor environment.

In accordance with a eight broad aspect there is provided, a system for the collection a mycotoxin sample from an air space of an indoor environment, the system including: an air agitator adapted to condition air of the air space to be representative of air exposed to a person within the indoor environment; a sampling apparatus including an inlet, a filter in communication with the inlet, a vacuum pump adapted to draw the conditioned air from the inlet through the filter at a rate representative of a human respiratory rate, the filter being adapted to scrub mycotoxins from the air at the rate; and a stand adapted to locate the inlet within the air space at a location that is representative of air exposed to a person within the indoor environment

In an aspect of the above, the height, or predetermined height, is between about 0.25 and 2.5 metres.

In another aspect, the height is about 1.1 to 1.8 metres.

In yet another aspect, conditioning the air includes agitating air of the air space.

In yet another aspect, agitating air of the air space includes operation of an air agitator.

In yet another aspect, the air agitator is operated at about the height.

In yet another aspect, filtering the airspace further representative of air exposed to the person includes drawing air through the filter at a rate representative of a human respiratory rate.

In yet another aspect, the rate is about 1 to 3 litres per minute.

In yet another aspect, the rate is about 2 litres per minute.

In yet another aspect, the filter includes foam material with a cell diameter of about 420-460 μm, and may include a primary filter and a secondary filter.

Further aspects and more specific features are disclosed below with reference to the accompanying figures.

### BRIEF DESCRIPTION OF THE FIGURES

The invention is described, by way of non-limiting example only, by reference to the accompanying figures, in which;

FIG. 1 illustrates a system for the collection of mycotoxins within the built environment;

FIG. 2 illustrates an example of a sampling apparatus of the system;

FIGS. 3a to 3e illustrate assembly steps of a filter cartridge for a filter unit of the apparatus; and

FIG. 4 is a flow chart illustrating a method for the collection of mycotoxins within the built environment.

### DETAILED DESCRIPTION

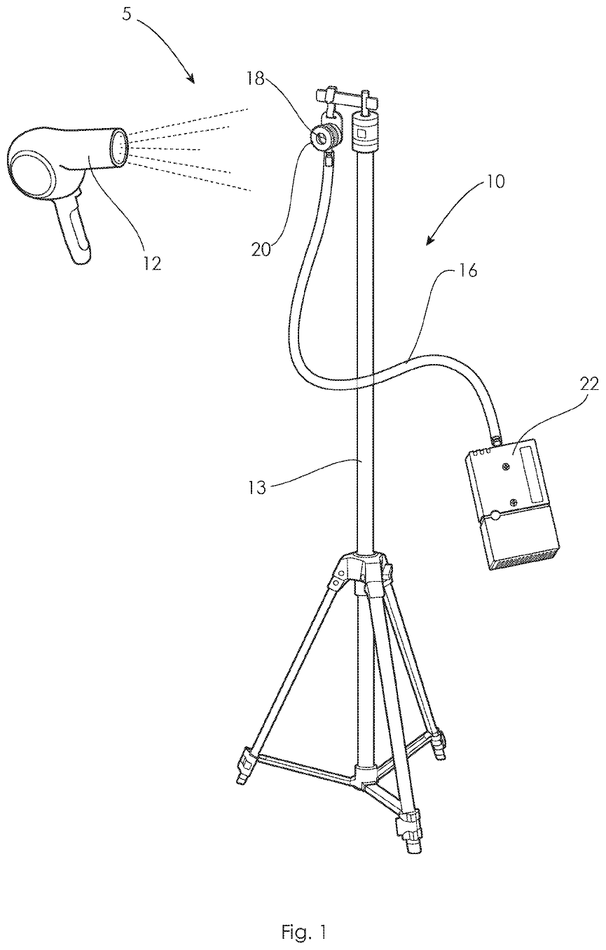

Referring to FIG. 1 there is shown a system 5 including an apparatus 10 for the collection, identification and quantification of mycotoxins within the built environment. Such mycotoxins may be those associated with fungus such as mould within the built environment. The built environment may include, but not limited to, housing, apartments or the like.

Mycotoxins, including but not limited to, Aflatoxins B1, B2, G1, G2, Ochratoxin A, Fumonisin, Vomitoxin, Zearelenone, T-2, HT-2, may be targeted through the below described respiratory size collection methods and then undergo direct analysis via quantitative analysis to determine the airborne concentration of given mycotoxins within the breathable air and reported in ppb (Parts per Billion) relative to the volume of air collected during the sampling period.

Turning initially to the system 5 in more detail, the system 5 may be adapted for the collection a mycotoxin sample from an air space of an indoor environment. The system 5 may include an air agitator 12 adapted to provide conditioned air of the air space to be representative of air exposed to a person within the indoor environment, the sampling apparatus 10 and a stand 13 to support the sampling apparatus 10.

The air agitator 12 may be a small blower or fan, either hand held or motorised, that stirs the air from a static condition to be more reflective of disturbed air that is common when a person is moving through and habiting an air space, such as walking through a room or moving items such as bed sheets or the like. The purpose of the agitation is to entrain any mycotoxins present so that the sample collected is reflective of the mycotoxins usually present.

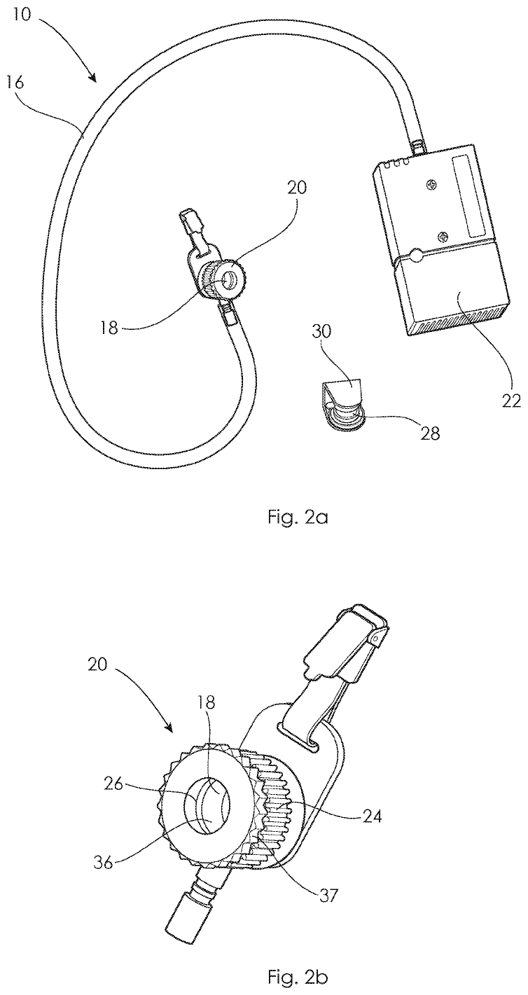

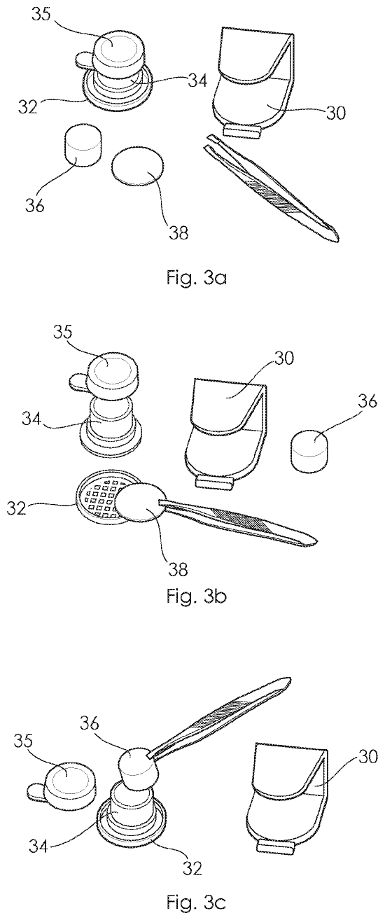

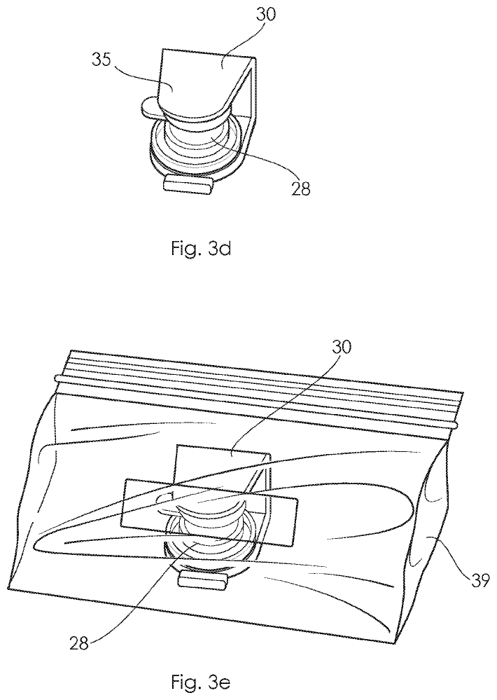

Referring in addition to FIG. 2a, 2b and FIGS. 3a to 3e, the sampling apparatus 10 may include an inlet 18, a filter unit 20 in communication with the inlet 18 and a vacuum pump 22 adapted to draw the conditioned air from the inlet 18 through the filter unit 20. In this example, the inlet 18 is provided at or via the filter unit 20 and a conduit 16 extends between the filter unit 20 and the vacuum pump 22.

The vacuum pump 22 is adapted to draw the conditioned air from the inlet 18 through the filter unit 20 at a rate representative of a human respiratory rate. The rate may be about, but not limited to, about 1 to 3 litres per minute and preferably about 2 litres per minute. An example of a suitable vacuum pump may be the AIRCHEK™ 52 available from Air-Met Scientific Pty Ltd.

Turning to the filter in more detail, the filter unit 20 includes a housing 24 with the inlet 18, and a filter arrangement 26 fitted to a filter cassette 28 that is fitted and removed in use from the housing 24. A threaded collar 37 is used to secure the filter cassette 28 of the housing 24.

Replacement cassettes 28 may be transported via a transport clip 30. The inlet 18 of the filter unit 20 may be covered by a cap to inhibit contamination prior to use.

The filter arrangement 26 includes a base 32 and a cylindrical body 34 in which a primary mycotoxin filter 36 is housed and a removable cap 35. The primary filter 36 in this example is a high-density foam filter adapted to capture mycotoxins from the air drawn there through. More specifically, the material of the primary filter 26 may be a foam such as a multi-dust foam disk.

In a preferred example, the primary filter 26 is constructed from polyurethane foam with a dimension of 12×16.5 mm with a cell diameter of 420-460 μm. It has been found that such a filter, normally used for dust, is suitable to collect mycotoxins from the air when filtered at a rate representative of respiration. A secondary thin filter 38 is also provided and the material of this filter may be, but not limited to, a 5 micron, 25 mm PVC filter. The foam of the primary filter 26 may be finer than the filter 38 and size of particle captured by the primary filter 26 is representative of respiratory size capture of the mycotoxins.

The filter unit 20 may be formed by modifying an existing filter unit such as IOM cartridge and such cartridges are available from SKC Ltd. However, such a filter is modified as shown in FIGS. 3a to 3e, and in particular, the primary filter 26 is added as shown. It is this primary filter 26 in which the mycotoxins are collected and then analysed. The components of the filter unit 20 should be carefully handled such as by using tweezers and the completed filter unit 20 or replacement cassette 28 are preferably to be stored in an airtight container such as a ziplock bag to inhibit contamination.

The stand 13 may take various forms and may be a tripod or the like that is adapted to locate the inlet 18 within the air space at a location that is representative of air exposed to a person within the indoor environment. For example, the stand 13 may be adapted to support the filter unit 20 with its inlet 18 at about the height of a person standing in a room, although the height may vary such as, but not limited to, between about 0.25 and 2.5 metres depending on the person and building type.

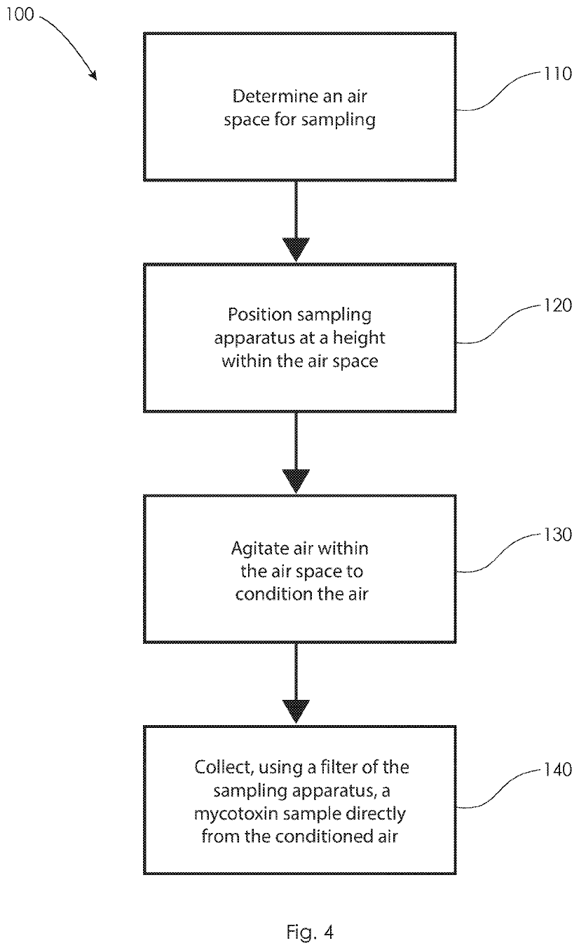

Turning now to a method 100 of use in more detail and referring to FIG. 4, the method 100 may include one or more of the following steps. However, prior to on-site collection the parts of the apparatus 10 are to be prepared, in particular, the filter units 20 and the removeable filter cassette 28. The removable cassettes 28 may initially be located in a sealed container such as a ziplock bag or the like.

Locations of one or more air spaces for the collection of samples may be determined at step 110, and it is preferable that these locations are locations of the potential high concentrations of mycotoxins. Such as, but not limited to, areas where an occupant may feel unwell, where there is evidence of fungal growth, areas with a history of water damage, and areas suspected of fungal growth.

The system 5 may then be assembled and positioned at step 120 at the selected location to sample air from an air space at the selected location. The stand 13 may be assembled and extended to a predetermined height representative of a breathing zone of a person and the filter unit 20 may be fitted to the stand 13 so the inlet 18 thereof is about at the predetermined height. The predetermined height may be about 0.25 to 2.5 metres, and preferably about 1.1 to 1.8 meters from the floor. The vacuum pump 22 may then be communicated with the filter unit 20 using the conduit 16. The flow rate of the vacuum pump 22 may be set to a rate of about 2 litres per minute so as to represent a human respiratory rate. The cap of the filter unit 20 may remain in place until sample collection is ready to commence.

Next, the air space proximate the filter unit 20 may be agitated at step 130 using the agitator such as the blower (not shown) to simulate what possible mycotoxins would become easily airborne through regular movement and condition with air to represent what a person in the air space would likely be exposed to. A domestic fan, an air paddle, or even a hair drier could be used to agitate the air.

The cap of the filter unit 20 may then be removed and the pump active to enable sample collection for a predetermined time period at step 140. The time period may vary, and may be, for example, 1 hour. Once sampling is complete, the pump may be deactivated and the cassette 28 may be removed from the body 24 of the filter unit 20. The cassette 28 which carried the foam filter 36 may then be sealed on a container such as a ziplock bag which may be labelled with information such as start and finish time for chain of custody documentation.

The cassette 28 may then be transported to a laboratory for analysis in which the cassette 28 is opened to remove the filter 36 and allow access to the mycotoxins for processing and analysis. Analysis methods may include enzyme-linked immunosorbent assay (ELISA), High-Performance Liquid Chromatography (HPLC), Mass Spectrometry, Gas Chromatography, quantitative and qualitative chemical luminescence analysis. Such analysis methods are well-known and not described herein any further.

As an example, the above system and method were used to obtain mycotoxin samples from the air within a building that were analysed to provide the results as shown in Table A below. In this example, tests were only conducted for Aflatoxins, and Ochratoxin A. The “Detection” column shows either “Not Detected”, meaning that the limit does not exceed the current published CODEX limit, or “Detected”, meaning that the sample exceeds the current published CODEX limit.

TABLE A
Example Test Results

| | RESULTS | | | | | |
|---|---|---|---|---|---|---|
| | Parts Per | | | | | METH- |
| TEST | Billion | | Micrograms | | Detection | OD |
| 13367-3 - LAB NO: | | | | | | |
| S190987 | | | | | | |
| Total Aflatoxin | <1.0 | ppb | <0.002 | μg | Not Detected | 03-S29 |
| Ochratoxin A | 2.4 | ppb | 0.005 | μg | Detected | 03-S26 |
| 13367-5 - LAB NO: | | | | | | |
| S190988 | | | | | | |
| Total Aflatoxin | <1.0 | ppb | <0.002 | μg | Not Detected | 03-S29 |
| Ochratoxin A | 2.2 | ppb | 0.004 | μg | Detected | 03-S26 |
| 13367-2 - LAB NO: | | | | | | |
| S190989 | | | | | | |
| Total Aflatoxin | <1.0 | ppb | <0.002 | μg | Not Detected | 03-S29 |
| Ochratoxin A | 2 | ppb | 0.004 | μg | Detected | 03-S26 |
| 13359 (Bathroom)- | | | | | | |
| 2 - LAB NO: | | | | | | |
| S190990 | | | | | | |
| Total Aflatoxin | <1.0 | ppb | <0.002 | μg | Not Detected | 03-S29 |
| Ochratoxin A | 2.3 | ppb | 0.005 | μg | Detected | 03-S26 |
| 13359 (Bedroom)- | | | | | | |
| 1 - LAB NO: | | | | | | |
| S190991 | | | | | | |
| Total Aflatoxin | <1.0 | ppb | <0.002 | μg | Not Detected | 03-S29 |
| Ochratoxin A | <2.0 | ppb | <0.004 | μg | Not Detected | 03-S26 |
| 13359 (Outside)- | | | | | | |
| 3- LAB NO: | | | | | | |
| S190992 | | | | | | |
| Total Aflatoxin | <1.0 | ppb | <0.002 | μg | Not Detected | 03-S29 |
| Ochratoxin A | <2.0 | ppb | <0.004 | μg | Not Detected | 03-S26 |
| 13359 (Outside)- | | | | | | |
| 4- LAB NO: | | | | | | |
| S190993 | | | | | | |
| Total Aflatoxin | <1.0 | ppb | <0.002 | μg | Not Detected | 03-S29 |
| Ochratoxin A | 2.1 | ppb | 0.004 | μg | Detected | 03-S26 |

Advantageously, there has been disclosed a targeted direct sampling method, system and apparatus for the collection of airborne mycotoxins. In particular, the targeted direct sampling method, system and apparatus allows for samples of mycotoxins that are representative of those that a person may be exposed to when normally respiring in a building. Further advantageously, a filter has been disclosed having properties that allows for collection of airborne mycotoxins at rates representative of human respiration.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

1. (canceled)

2. A method of collection of a mycotoxin sample from an air space of an indoor environment representative of human mycotoxin exposure, the method including: agitating air within the air space using air agitator to provide conditioned air representative of air exposed to a person within the indoor environment, and filtering the conditioned air at a height within the airspace further representative of air exposed to the person within the indoor environment so as to obtain the mycotoxin sample from the conditioned air at the height, wherein the filtering includes drawing the conditioned air through at least a primary filter formed substantially of a foam material adapted to collect the mycotoxin sample at a rate of about 1 to 3 litres per minute.

3. The method according to claim 2, wherein the height is between about 0.25 and 2.5 metres.

4. The method according to claim 2, wherein the height is about 1.1 to 1.8 metres.

5. (canceled)

6. (canceled)

7. The method according to claim 2, wherein the air agitator is operated at about the height.

8. (canceled)

9. (canceled)

10. The method according to claim 2, wherein the rate is about 2 litres per minute.

11. A method of collection of a mycotoxin sample from an air space of an indoor environment representative of human mycotoxin exposure, the method including: positioning an inlet of a sampling apparatus proximate the air space at a predetermined height; agitating air of the air space using an air agitator to provide conditioned air that is representative of air exposed to a person within the indoor environment; and sampling conditioned air from the air space using a filter arrangement including a primary foam filter and a secondary filter of the sampling apparatus exposed to the conditioned air drawn through the inlet to collect the mycotoxin sample in the filter arrangement at rate of about 1 to 3 litres per minute.

12. (canceled)

13. (canceled)

14. (canceled)

15. (canceled)

16. (canceled)

17. (canceled)

18. (canceled)

19. A system for the collection a mycotoxin sample from an air space of an indoor environment, the system including:
a. An air agitator adapted to condition air of the air space to be representative of air exposed to a person within the indoor environment;
b. A sampling apparatus including an inlet, a filter arrangement in communication with the inlet, a vacuum pump adapted to draw the conditioned air from the inlet through the filter arrangement at a rate of about 1 to 3 litres per minute, the filter arrangement including a primary filter formed of a foam material being adapted to scrub mycotoxins from the air at the rate; and
c. A stand adapted to locate the inlet within the air space at a height that is representative of air exposed to a person within the indoor environment.

20. The system according to claim 19, wherein the filter Includes-foam material has a cell diameter of about 420-460 μm.

21. The system according to claim 19, wherein the stand supports the inlet at about the height of a person in the range of about 1.1 to 1.8 meters.

22. (canceled)

23. The system according to claim 19, wherein the foam material of the primary filter is a polyurethane foam.

24. The system according to claim 19, wherein the filter arrangement includes a secondary filter

25. The system according to claim 24, wherein the secondary filter is about a 5 micron filter.

26. The system according to claim 24, wherein the secondary filter is a Polyvinyl Chloride (PVC) filter.

27. The method according to claim 2, wherein the foam material of the primary filter has a cell diameter of about 420-460 μm.

28. The method according to claim 2, wherein the foam material of the primary filter is a polyurethane foam.

29. The method according to claim 2, wherein the filtering further includes drawing the air through a secondary filter.

30. The method according to claim 29, wherein the secondary filter is about a 5 micron filter.

31. The method according to claim 29, wherein the secondary filter is a Polyvinyl Chloride (PVC) filter.
